(19) United States
(12) Patent Application Publication
(10) Pub. No.: US 2018/0162328 A1
(43) Pub. Date: Jun. 14, 2018

(54) METHOD FOR USE OF VEHICLE CLEANING APPARATUS

(71) Applicant: Emmanuel H Williams, Detroit, MI (US)

(72) Inventor: Emmanuel H Williams, Detroit, MI (US)

(21) Appl. No.: 15/334,272

(22) Filed: Oct. 25, 2016

Related U.S. Application Data
(63) Continuation-in-part of application No. 12/618,030, filed on Nov. 13, 2009, now abandoned.

(51) Int. Cl. B60S 3/04; B08B 3/02

(52) U.S. Cl. CPC B60S 3/047; B08B 2230/01; B08B 3/026

(57) ABSTRACT

A method for cleaning vehicle exteriors using a stream of pressurizes steam. Preferably the stream of pressurized steam has a pressure in the range of 65 to 75 psi and is supplied at a temperature in the range of 295 to 310 degrees ° F. After applying the steam to a portion of a vehicle exterior surface and subjecting a first cloth to a stream of the pressurized stream, the vehicle's surface is first wiped with the first cloth and then wiped with a dry second cloth, resulting in removal of all contaminants from a vehicle's surface as well as polishing of the vehicle's surface. This method is repeated to clean the entire vehicle. The method eliminates the use of environmental pollutants such as soaps and the need to collect any such pollutants during the vehicle cleaning process.

### CROSS-REFERENCE TO RELATED APPLICATIONS

The present disclosure is a continuation in part of and claims priority 35 United States Code, Section 120 to U.S. Non-provisional patent application Ser. No. 12/618,030, filed on Nov. 13, 2009, the disclosure of which is incorporated by reference

### FIELD OF THE INVENTION

The present invention relates generally to an apparatus and method for cleaning vehicles. More particularly, the present invention relates to an apparatus and method utilizing steam to clean vehicles.

### BACKGROUND OF THE INVENTION

Commercial car washes are prevalent in urban and rural areas. Such facilities range from fully automatic drive-through systems to do-it-yourself stations where the vehicle driver must perform the rinsing and scrubbing him- or herself. In a typical do-it-yourself system, the cleaning supplies are provided to the driver or other person that will be washing the car. The supplies include a cleaning solution of some sort, a wand that is equipped to spray water and the cleaning solution on the car, and a brush for scrubbing the vehicle during cleaning. The spray wand may include a feature for selecting between low- and high-pressure streams of water.

Alternatively to using commercial car washes, many people also wash their vehicle at their residence. This typically involves the use of a hose, brushes, and car wash detergent.

A problem associated with such traditional car washes is the volume of unnecessary water used in these wash processes. A considerable amount of water is wasted during cleaning and rinsing the vehicle. In commercial car washes, the amount of water used is usually predetermined without regard to the size of the vehicle such that water is wasted if the vehicle does not require the entirety of the predetermined amount to complete the wash process.

Detergents used in these processes create another undesirable form of waste. These traditional car wash systems require the use of soap to remove dirt, grime, and other surface contaminants from the washed vehicle. Detergents are effective in cleaning vehicles, however, such detergents must be rinsed from the vehicle as part of the wash process and can pollute groundwater or otherwise must be handled by municipal water treatment facilities, which requires added energy and cost on the part of such facilities. Additionally, because detergents must be rinsed from the washed vehicle (to prevent residue from building up on the vehicle), an additional step is required in the wash process that involves the use of more water.

Furthermore, local and state environmental regulations often require commercial car wash operators to collect detergent run-off for subsequent filtering or specialized disposal, which also involves additional cost, time, and energy as a part of such an operation. The varying nature of the particular local and state regulations require such commercial car wash operators to customize their waste-collection operations to meet a variety of regulatory and statutory schemes. This customization to fit a variety of such schemes adds further cost to the operation, or may prove to be a barrier to geographic expansion of such an endeavor.

In connection with such automatic, and commercial do-it-yourself car washes, and residential car washes an external water supply is required. The necessary incorporation of an external water supply further limits the possible location of these car washes, i.e., they must be located in proximity to an external water supply and the geographic areas in which the wash can be operated is limited accordingly. The requirement of an external water supply also limits the capability of portable car wash systems that are known in the art.

Given the state of the prior art, there exists a need for an efficient car wash system that is portable for use in any area in which a vehicle may be parked, that uses reduced volumes of water, and that does not pollute groundwater. The system should also effectively remove dirt, wax, and other contaminants from the surface of a vehicle's exterior. A system that does not fall under the scope of varying state and local regulations regarding the collection, treatment, and disposal of used detergents is also needed.

### SUMMARY OF THE INVENTION

The method for cleaning vehicles in accordance with the present invention comprises the steps of: 1) applying a stream of pressurized steam to a portion of the exterior surface of a vehicle such that at least a portion of the stream of pressurized steam condenses on the vehicle surface; 2) applying a stream of pressurized steam to a first cloth; 3) wiping the condensed stream from the vehicle surface with a first cloth; 4) wiping the vehicle surface with a dry second cloth; and 5) repeating steps 1-4 to clean the exterior surface of the vehicle. The method may additionally include the step of pre-treating the first cloth prior to step 2. The first cloth may comprise double-sided loop pile and the second cloth may comprise 100% smooth cotton or, in a preferred embodiment, may comprise a microfiber material.

The stream of pressurized steam preferably has a pressure in the range of 50 to 85 psi, more preferably in the range of 65-75 psi. In another embodiment, the stream of pressurized steam has a pressure in the range of 40-120 psi. The stream of pressurized steam is preferably at a temperature in the range of 295° F. to 310° F. (approximately 145° C. to 155° C.), more preferably to a temperature in the range of 300° F. to 305° F. (approximately 148° C. to 152° C.

The stream of pressurized steam is preferably applied onto the exterior vehicle surface from a distance greater than approximately 12 inches from said portion of the exterior surface. The stream of pressurized steam may be applied onto the vehicle surface using a back and forth motion. The back and forth motion is preferably repeated at least 5 times.

At least a portion of said stream of pressurized steam may be applied onto the vehicle surface by scrubbing the vehicle surface with a wand having a brush attachment attached thereto. The brush attachment may comprise a brush head attachment; a sponge centrally disposed in the brush head attachment; one or more rows of bristles extending outward from the brush head attachment; and a cloth cover surrounding at least a portion of the brush attachment.

The steam cleaning apparatus in accordance with the present invention comprises a reservoir for storing water to be used by the steam cleaner; a heating coil in communication with the reservoir, the heating coil heating the water to form steam at a given temperature and pressure; and a wand fitted with a brush attachment. The brush attachment comprises a brush head attachment; a sponge centrally disposed in the brush head attachment; one or more rows of bristles extending outward from the brush head attachment; and a cloth cover surrounding at least a portion of the brush attachment. The brush attachment may be detachably connected to the wand.

These together with other aspects of the present invention, along with the various features of novelty that characterize the invention, are pointed out with particularity in the claims annexed hereto and forming a part of this disclosure. For a better understanding of the invention, its operating advantages and specific objects attained by its uses, reference should be had to the accompanying drawings and descriptive matter in which there are illustrated exemplary embodiments of the present invention.

### BRIEF DESCRIPTION OF THE DRAWINGS

FIG. 1, is a depiction of a steam cleaner in accordance with the present invention.

FIG. 2, is a graph showing the temperature and pressure of saturated steam as used in accordance with the present invention.

FIG. 3, is a depiction of a wand as used in conjunction with the steam cleaner in accordance with the present invention.

FIG. 4, is a depiction of a brush attachment as used in accordance with the present invention.

FIG. 5, is a depiction of a cloth cover as used in accordance with the present invention.

### DETAILED DESCRIPTION OF THE PREFERRED EMBODIMENTS OF THE PRESENT INVENTION

Disclosed herein is a method and apparatus utilizing steam to clean the exterior surface of vehicles. The present invention provides for efficient cleaning of the exterior surface of vehicles without wasting water and without using detergents or other chemicals which may be harmful to the environment. By minimizing the use of water and eliminating the need for costly detergents and/or chemicals, utilization of the method and apparatus disclosed herein may also provide many cost advantages. Furthermore, the present invention may be used to clean vehicles in confined areas without the need to consider runoff or draining of water. The use of steam allows the present invention to easily remove oil, salt, dirt, soap, bird droppings, insect residue, and mud from the exterior surface of vehicles without damaging the vehicle finish, and further, allows full removal of such contaminants and polishing of the vehicle's surface as part of the cleaning process.

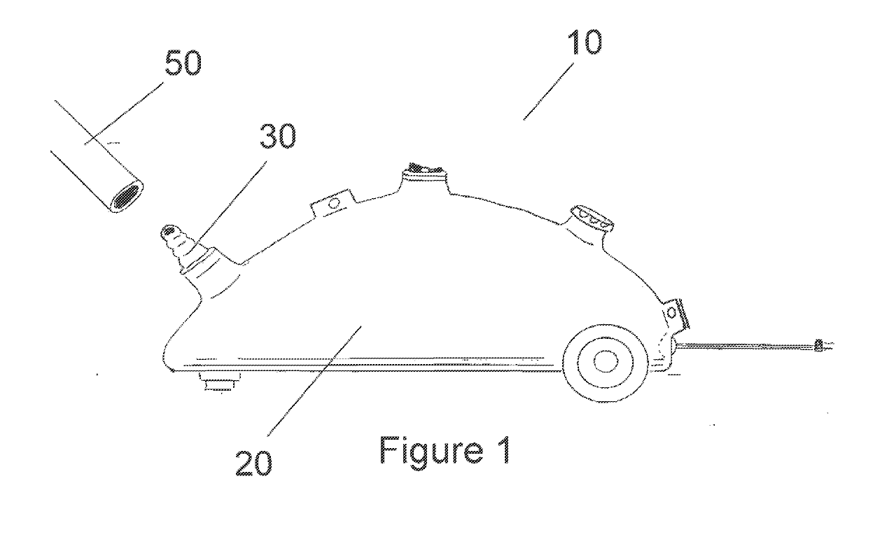

The cleaning apparatus in accordance with the present invention generally comprises a steam cleaner equipped with a wand for applying steam to a vehicle surface. The steam cleaner 10, as generally depicted in FIG. 1, generally comprises a reservoir 20 for storing water to be used by the steam cleaner. Preferably, the steam cleaner reservoir has a capacity of at least one gallon of distilled water. With a steam cleaner that features a one gallon water reservoir, the operator may clean five or six typical-sized passenger vehicles before the reservoir needs to be refilled. This provides for effective water conservation as compared to a typical washing apparatus. If the operator desires to clean more vehicles in one session, he or she may employ a steam cleaner that has a larger reservoir. The reservoir 20 includes a heating coil that, when activated, converts the water contained therein to steam. After such activation, the steam is discharge through an outlet 30 of the steam cleaner 10. Steam expelled through the outlet of the steam cleaner may be directed through a wand 40 for application onto a vehicle that is to be cleaned. The steam cleaner 10 may be powered by a connection to grounded electrical outlet, an integrated battery, or an electrical generator. The steam cleaner 10 may be mobile or static. When static, a water filtration system may be used to provide the steam cleaner with a continual source of purified water. When mobile, a water filtration system may be integrated with the steam cleaner such that steam cleaner may use unpurified water.

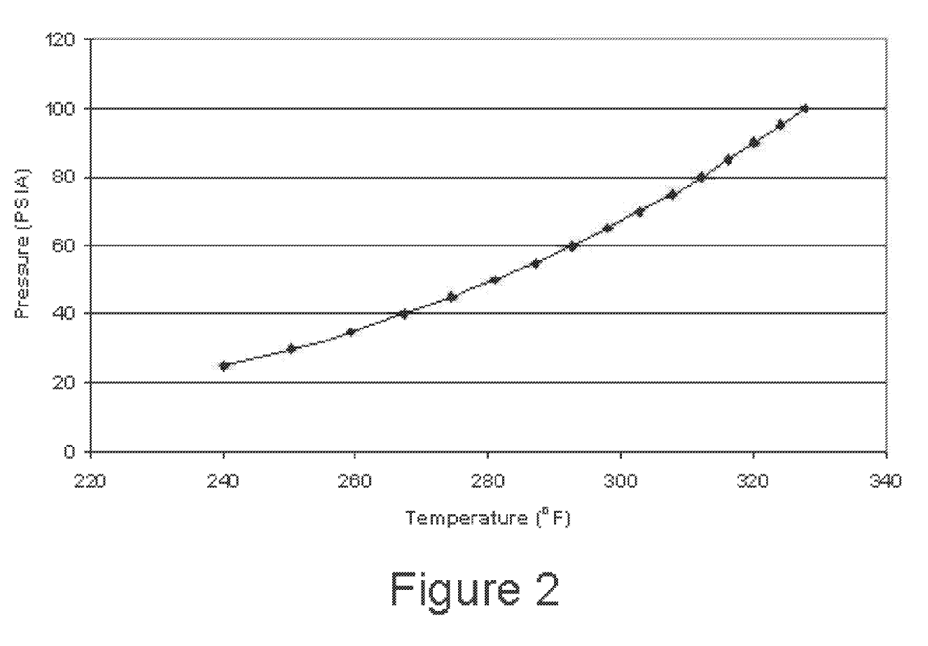

The pressure of the steam provided from the steam cleaner 10 may be varied based on the needs of the user. Preferably, the steam provided from the steam cleaner is saturated steam. Saturated steam used in accordance with the present invention may have a pressure and temperature corresponding with the properties for saturated steam as shown in FIG. 2. Preferably, the pressure of the steam provided by the steam cleaner is in the range of 50 to 85 psia, more preferably, 65 to 75 psia. The temperature of the steam provided from the steam cleaner may also be varied based on the needs of the user. Preferably, the steam discharged from the wand is supplied at a temperature in the range of 295° F. to 310° F. (approximately 145° C. to 155° C.), more preferably at a temperature in the range of 300° F. to 305° F. (approximately 148° C. to 152° C.).

While various types of water may generally be used with steam cleaners, preferably distilled water is used with the apparatus disclosed herein. Other types of purified water may also be used in accordance with the present invention. The use of distilled or purified water allows for improved cleaning of the vehicle surface and better operation of the steam cleaner due to the lack of impurities in the distilled or purified water as compared to tap or well water. The removal of impurities permits excess water that remains on the vehicle after the steam has been sprayed thereon to dry without leaving spots and thus increases the appeal and effect of the method. Furthermore, the presence of impurities in the water may cause excessive maintenance for the steam cleaner due to clogged lines.

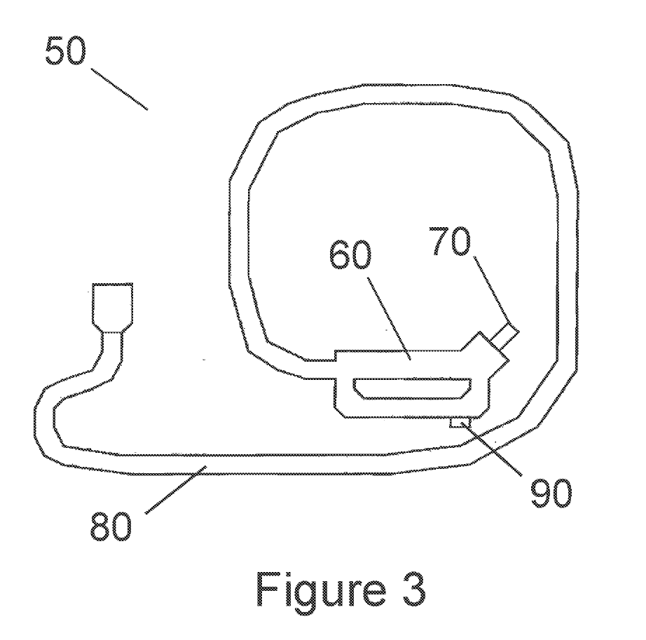

A general depiction of a wand that may be used in accordance with the present invention is shown in FIG. 3. The wand 50 utilized with the steam cleaner generally comprises a tubular section 60 through which steam is provided from the steam cleaner. A nozzle 70 is located at the end of the tubular section 60 through which the steam is expelled. The end of the wand opposite the nozzle is attached to the steam cleaner via tubing 80 through which steam is supplied from the steam cleaner 10. The wand may also include a button/trigger 90 which is biased in a normally off position thereby preventing steam from flowing into and being dispensed from the wand. When the button/trigger is actuated, steam flows through the wand and is dispersed through the nozzle 70. The wand 50 may also include a steam flow regulator to control the flow of steam through the wand.

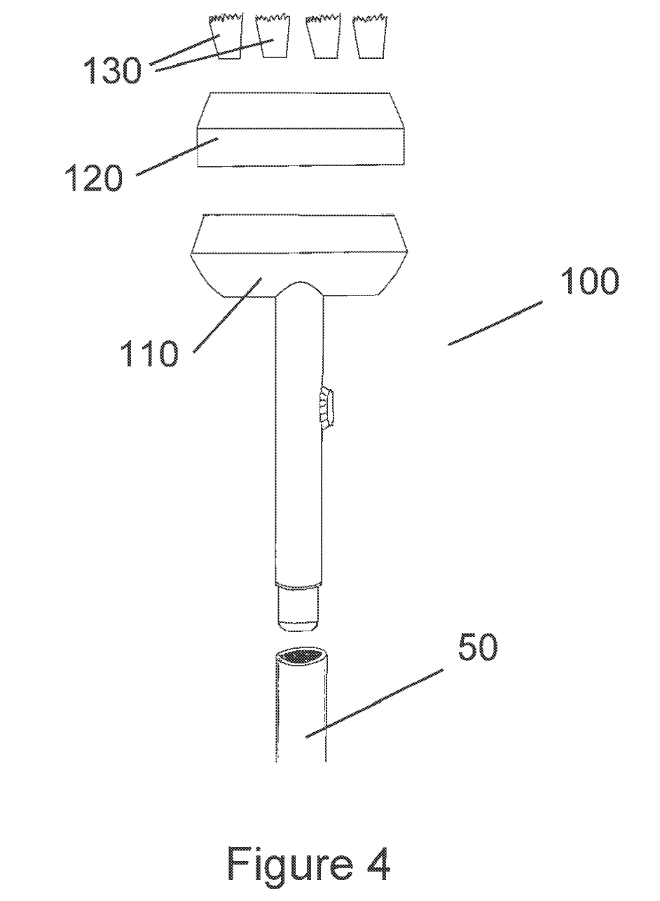

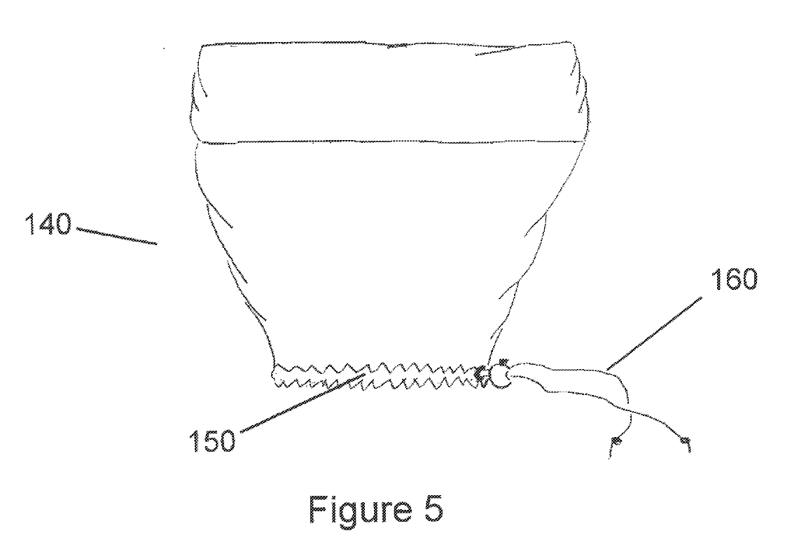

In an alternative embodiment of the present invention, the nozzle 70 of the wand may be fitted with a brush attachment. An exploded view of a brush attachment in accordance with the present invention is shown in FIG. 4. The brush attachment 100 may be detachably connected to the wand 50. The brush attachment may be used to scrub the exterior of a vehicle which may aid in removing built up residue/dirt from the exterior surface of the vehicle. The brush attachment 100 comprises a brush head attachment 110 which connects onto the distal end of the wand. A sponge 120 is centrally disposed in the brush head attachment. The sponge acts to dissipate the stream of pressurized steam and provide a surface for the steam to condense upon as the steam exits the wand so as not to damage the vehicle finish. The brush head attachment may also include one or more rows of bristles 130 which aid in scrubbing the vehicle exterior surface. A cloth cover may be placed over the brush head attachment. A depiction of a cloth cover in accordance with the present invention is shown in FIG. 5. The cloth cover 140 helps prevent damage to the vehicle surface due to scrubbing with the brush. The cloth cover may be double sided loop pile. In another embodiment, the cloth cover may be microfiber, and in a further embodiment, pie wedge microfiber with a diameter of no more than 10 microns or less. The cloth cover may have a bag type design with the open end 150 having draw strings 160 to secure the cloth cover over the brush attachment 100. During use, the stream of pressurized steam flows through the wand and contacts the sponge 120. The stream is dissipated and partially condenses on the brush attachment. The remaining portion of the stream of pressurized steam passes through the brush attachment and may be applied to the exterior vehicle surface. The remaining pressurized steam and the condensed steam may then be used to clean the exterior vehicle surface in conjunction with the brush attachment.

The method for cleaning vehicles may utilize the steam cleaner as described herein to accomplish the cleaning. Other steam cleaners may be used in accordance with the method disclosed herein provided they are able to provide pressurized steam with the requisite temperature and pressure. As previously described, the steam cleaner 10 is preferably equipped with a wand 50 that expels pressurized steam.

To clean the exterior surface of the vehicle, the operator manipulates the wand 50 of the steam cleaner 10 such that the wand 50 sprays steam onto at least a portion of the exterior surface of the vehicle. Preferably, the nozzle 70 of the wand is maintained at a distance greater than approximately 12 inches from the vehicle surface. The steam will heat the surface of the vehicle and disturb contaminants that lie on the surface of the vehicle such that, after applying steam to at least a portion of the surface of the vehicle, the operator then wipes the vehicle's surface with a first cloth to remove those contaminants from the surface. To reduce streaking and leaving such undesirable substances on the surface of the vehicle, the operator should wipe the first cloth in a consistent direction over the entire surface of the vehicle. To improve the first cloth's ability to remove contaminants from the surface of the vehicle, the operator should pre-treat the first cloth with a stream of steam from the wand 50 of the steam cleaner 10 prior to wiping the vehicle's surface with the first cloth.

The first cloth used to wipe and remove contaminants from the surface of the vehicle has the ability to absorb more than its weight in moisture. In one embodiment of the present disclosure, the first cloth is made of cotton and is in the form of a double-sided loop pile. The first cloth is preferably at least 12×12 inches in size.

After the operator has sprayed steam from the steam cleaner 10 on to the exterior surface of the vehicle and onto the first cloth, and has subsequently wiped off the applied steam with the first cloth and while the surface of the vehicle remains heated from the application of steam, the operator then wipes the vehicle with a second cloth to complete the cleaning process. The second cloth is a dry cloth as practiced in the method. In one embodiment of the invention, the second cloth is composed of 100% smooth cotton. In another embodiment, the second cloth may be microfiber, and in a further embodiment, pie wedge microfiber with a diameter of no more than 10 microns or less. This composition of the dry second cloth restores the appearance of clear-coat paint finishes to an approximation of their factory appearance, i.e., the dry second cloth both removes residual contaminants and polishes the surface of the vehicle as is described in more detail elsewhere herein. The second cloth is preferably at least 12×12 inches in size. In the event that the second cloth being used by the operator becomes damp or wet, the operator replaces that particular second cloth with another second cloth that is dry.

As steam is discharged from the wand 50 and applied on the exterior surface of the vehicle, the operator manipulates the wand 50 back and forth repeatedly over a limited portion of the vehicle until the desired limited portion is covered by condensed vapor resulting from the steam condensing on the vehicle surface. In an embodiment, the operator repeats this back and forth manipulation at least five times.

After this manipulation of the wand 50 over a selected portion of the vehicle's surface and upon a first cloth, the operator wipes off the condensed steam in the applied area with the first cloth. With the operator wiping the vehicle surface with the first cloth with nominal pressure while the surface of the vehicle is still heated, the first cloth removes dirt, oil, wax, bird droppings, insect residue, and other residue and contaminants from the vehicle surface. The operator then wipes the selected area of the vehicle, while that area of the vehicle is still heated from the application of steam, with a dry second cloth to remove any residual undesired substances and to polish the surface of the vehicle in the process. This completes the disclosed cleaning process in that area of the vehicle. The process may be repeated until all of the vehicle's surface has been so treated, cleaned and polished.

The disclosed method of steam cleaning contemplates spraying a vehicle in such a controlled manner that overspray, or the spray of water in an unintended area, is avoided. This controlled spraying allows the operator to perform the method in an enclosed area or in restricted space such as a parking lot or parking structure. The use of a first cloth and then a second, dry, cloth, obviates the need for additional equipment (such as vacuums or blowers) to complete the cleaning process.

The following advantages were discovered during the inventive process: The second cloth of the method of the present application has resulted in improved and/or unexpected results that the cited references do not teach or suggest. The second cloth is a dry cloth. The prior art does not teach applying a second dry cloth immediately after the surface of the vehicle has been heated by steam. The claimed method applies the second dry cloth immediately after wiping the vehicle's surface with a wet cloth. It was discovered in the inventive process that only such a second dry cloth could perform effective removal of remaining contaminants and perform such cleaning without scratching the surface of the vehicle. The use of the claimed method's dry second cloth occurs when the surface of the vehicle is still relatively heated and still is in atmospheric proximity to the previously applied steam.

It was discovered in the inventive process that the use of the claimed method's dry second cloth under such circumstances (while the surface of the vehicle is still heated atmospheric presence of steam) yielded unexpected results, namely, the contaminants that remain on the vehicle's surface after the first cloth of the method wipes the surface are removed by the second cloth of the method, and further, the second cloth of the method polishes the surface of the vehicle.

The second cloth of the claimed method, when the method is practiced, effectively removes remaining contaminants due to a static charge that is generated by friction between the dry cloth and the heated surface. The second cloth of the claimed method, when the method is practiced, polishes surface of the vehicle because the contaminants that remained on the vehicle's surface after the surface was wiped with the first cloth are subsequently removed by and absorbed into a portion of the second cloth (via the static charge mentioned above) and because the remaining portion of the second cloth, wiping the contaminant-free surface, is able to polish that surface due to the surface of the vehicle still being hot (heat being a requisite condition for effective polishing) as well as the lack of contaminants on the surface or the cloth.

The use of the second cloth of the claimed method sufficiently cleans the vehicle's surface such that the need for further wiping or cloths is eliminated. This use of the second cloth that removes all remaining contaminants from the surface of the vehicle is an unexpected or improved level of performance of a cloth and the claimed cleaning method, particularly in view of the prior art. This use of the second cloth that polishes the surface of the vehicle is an unexpected or improved level of performance of a cloth and the claimed cleaning method, particularly in view of the prior art.

In fully removing contaminants from the surface and polishing the surface by the claimed method, the claimed method accomplishes cleaning and restoration of a vehicle's surface that the prior art cannot accomplish and that can only otherwise be accomplished by incorporating other implements, such as using a clay bar to remove contaminants and/or a buffer or polisher to restore luster to the vehicle's surface. The claimed method eliminates the need to use such extra implements but still achieves the same level of cleaning and restoration.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, to thereby enable others skilled in the art to best utilize the disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

1. A method for cleaning vehicles comprising the steps of:
1) applying a stream of pressurized steam to a portion of the exterior surface of a vehicle such that at least a portion of said stream of pressurized steam condenses on said vehicle surface and heats the vehicle surface;
2) wiping the condensed steam from said portion of said vehicle surface with a first cloth;
3) wiping said portion of said vehicle surface with a dry second cloth while said portion of said vehicle surface is still heated by said steam, said second cloth comprising a microfiber material, in a single back and forth motion;
4) repeating steps 1-3 on other portions of the exterior surface of the vehicle to clean the exterior surface of the vehicle.

2. The method according to claim 1, wherein said stream of pressurized steam has a pressure in the range of 65 to 75 psi.

3. The method according to claim 1, wherein said stream of pressurized steam has a temperature in the range of 295 to 310° F.

4. The method according to claim 1, wherein said stream of pressurized steam has a temperature in the range of 300 to 305° F.

5. The method according to claim 1, wherein said first cloth comprises double-sided loop pile.

6. The method according to claim 1, wherein said second cloth comprises 100% smooth cotton.

7. The method according to claim 1, wherein said stream of pressurized steam comprises distilled water vapor.

8. The method according to claim 1, wherein said stream of pressurized steam is applied onto said portion of the exterior surface of the vehicle from a distance greater than approximately 12 inches from said portion of the exterior surface.

9. The method according to claim 1, wherein said stream of pressurized steam is applied onto said vehicle surface using a back and forth motion.

10. The method according to claim 9, wherein said back and forth motion is repeated at least 5 times.

11. The method according to claim 1, wherein said stream of pressurized steam comprises saturated steam.

12. The method according to claim 1, wherein at least a portion of said stream of pressurized steam is applied onto said vehicle surface by scrubbing said vehicle surface with a wand having a brush attachment comprising:
a brush head attachment;
a sponge centrally disposed in the brush head attachment one or more rows of bristles extending outward from the brush head attachment; and
a cloth cover surrounding at least a portion of the brush attachment.

13. The method according to claim 1 further comprising the step of pre-treating said first cloth with said stream of pressurized steam prior to step 2.

14. The method according to claim 1, wherein said stream of pressurized steam has a pressure in the range of 40 to 120 psi.

15. The method according to claim 1, wherein said stream of pressurized steam is applied onto said portion of the exterior surface of the vehicle from a distance no greater than approximately 12 inches from said portion of the exterior surface.
